(19) United States
(12) Patent Application Publication
(10) Pub. No.: US 2003/0081848 A1
(43) Pub. Date: May 1, 2003

(54) Image encoder, image encoding method and image-encoding program

(76) Inventor: Yuji Wada, Yokosuka-Shi (JP)

Correspondence Address: JACOBSON HOLMAN, PROFESSIONAL LIMITED LIABILITY COMPANY, 400 Seventh Street, N.W., Washington, DC, 20004, US

(21) Appl. No.: 10/277,982

(22) Filed: Oct. 23, 2002

(30) Foreign Application Priority Data
Oct. 29, 2001 (JP) 2001-331074

(51) Int. Cl. G06K 9/36; G06K 9/46

(52) U.S. Cl. 382/240; 382/247

(57) ABSTRACT

An input image is divided into several tile blocks. Wavelet transform is applied to each tile block. At least one region of the wavelet-trans formed data is appointed as a region of interest. The region to be appointed as the region of interest is located in each tile block and in the vicinity of tile border lines. Coefficient-bit modeling is applied to the transformed data for which the region of interest has been set, thus a bit train being generated specific bits of the bit train are truncated and the truncated bit train is converted into byte codes. A bitstream is generated based on the truncated and byte-code-converted bit train. The region-of-interest appointment may be carried out only when a compression rate for the input image reaches a certain level or higher.

### BACKGROUND OF THE INVENTION

The present invention relates to an image encoder, an image encoding method and an image-encoding program for image compression under the encoding standard JPEG2000.

There are several image compression techniques such as the most general technique JPEG. Among them, JPEG2000 recently decided as the international image-compression standard has attracted wide attention.

Different from the known JPEG using discrete cosign transform (DCT), JPEG2000 uses wavelet transform (DWT) for higher image quality, higher gradation in image, higher compression rate, and so on.

An image encoder under JPEG2000 has a tiling function of tiling input images. Illustrated in FIG. 1 is an input image 10 that has undergone tiling. The input image 10 has been divided into several tile blocks 11 with tile border lines 12. The tiled image data undergoes wavelet transform for each tile block 11.

JPEG2000-encoding with wavelet transform offers images of higher quality than the known JPEG-encoding with DCT transform, as discussed above. Nevertheless, JPEG2000 with the tiling function suffers low image quality in the vicinity of the tile border lines 12 shown in FIG. 1 in compression at low bit rate (at relatively high compression rate), thus generating tiling noises. Such tiling noises will also be generated at low bit rate in decoding even high bit-rate compression is performed.

Tiling noises are caused by wavelet transform with a technique called “symmetrical periodic extension” around the tile border lines 12 in FIG. 1.

Symmetrical periodic extension is illustrated in FIG. 2 for computation of a pixel a₀ to be transformed by real-number type wavelet transform.

Wavelet transform to the pixel a₀ in the middle section of the tile block 11 is performed with data of pixels a₁ to a₄ and pixels a₅ to a₈ symmetrically aligned in both sides of the pixel a₀, and hence no problems will occur.

On the contrary, wavelet transform is impossible for a pixel b₀ to be transformed located near a tile border line 12 as indicated in FIG. 2, because no pixels exist in the right side of the line 12 even though pixels b1 to b4 exist in the left side. In other words, wavelet transform is performed independently in each tile block and cannot use pixels located in neighboring tile blocks.

Virtual pixels b₄ to b₁ (enclosed by dot blocks) are then aligned in the right side, as symmetrical with the real pixels b₁ to b₄ located in the left side. Wavelet transform is performed with data of the real pixels b₁ to b₄ and those of the virtual pixels b₁ to b₄, which is called “symmetrical periodic extension”.

Symmetrical periodic extension, however, suffers low computation accuracy because of using virtual pixel data, compared to using real pixel data located in neighboring tile blocks, if allowed. Such low computation accuracy would not be noticeable at compression rate of a specific level or lower, however, could be noticeable on intensity, brightness, color difference, etc., between the original data and compressed data at compression rate over the specific level. Moreover, difference in data in the vicinity of the tile border lines 12 could be noticeable due to no relations between adjacent tile blocks 11, which resulting in lines (along the tile border lines 12) appearing on monitor screen, as tiling noises.

Average-value filtering may be applied to the tile border lines 12 and peripheral areas to prevent tiling noises. The average-value filtering could, however, be the cause of low image quality and hence not feasible for aiming high image quality.

Instead, data of the virtual pixels b4 to b1 could be computed using data of the real pixels b1 to b4, which could, however, resulting in complex computation and hence low processing speed.

### SUMMARY OF THE INVENTION

A purpose of the present invention is to provide an image encoder, an image encoding method and an image-encoding program, achieving high image quality and computation speed while suppressing tiling noises.

The present invention provides an image encoder for compressing an input image, including: a tiling unit to divide the input image into a plurality of tile blocks; a wavelet transformer to apply wavelet transform to each tile block; a region-of-interest appointer to appoint at least one region of the wavelet-transformed data as a region of interest, the region to be appointed as the region of interest being located in each tile block and in the vicinity of tile border lines; a coefficient-bit modeling unit to apply coefficient-bit modeling to the transformed data for which the region of interest has been set, thus generating a bit train; a truncation/arithmetic-coder to truncate specific bits of the bit train and convert the truncated bit train into byte codes; and a bitstream generator to generate a bitstream based on the truncated and byte-code-converted bit train.

Moreover, the present invention provides a method of image encoding to compress an input image, including the steps of: dividing the input image into a plurality of tile blocks; applying wavelet transform to each tile block; appointing at least one region of the wavelet-transformed data as a region of interest, the region to be appointed as the region of interest being located in each tile block and in the vicinity of tile border lines; applying coefficient-bit modeling to the transformed data for which the region of interest has been set, thus a bit train being generated; truncating specific bits of the bit train and converting the truncated bit train into byte codes; and generating a bitstream based on the truncated and byte-code-converted bit train.

Furthermore, the present invention provides a computer-readable program for compressing an input image, including: computer-readable program code means for dividing an input image into a plurality of tile blocks; computer-readable program code means for applying wavelet transform to each tile block; computer-readable program code means for appointing at least one region of the wavelet-transformed data as a region of interest, the region to be appointed as the region of interest being located in each tile block and in the vicinity of tile border lines; computer-readable program code means for applying coefficient-bit modeling to the transformed data for which the region of interest has been set, thus a bit train being generated; computer-readable program code means for truncating specific bits of the bit train and converting the truncated bit train into byte codes; and computer-readable program code means for generating a bitstream based on the truncated and byte-code-converted bit train.

### BRIEF DESCRIPTION OF THE DRAWINGS

FIG. 1 illustrates an input image that has undergone tiling;

FIG. 2 illustrates symmetrical periodic extension in wavelet transform.

FIG. 3 shows a block diagram of an embodiment of image encoder according to the present invention; and

FIG. 4 illustrates an image for which several regions have been appointed as regions of interest by a region-of-interest appointing function according to the present invention.

### DESCRIPTION OF THE PREFERRED EMBODIMENT

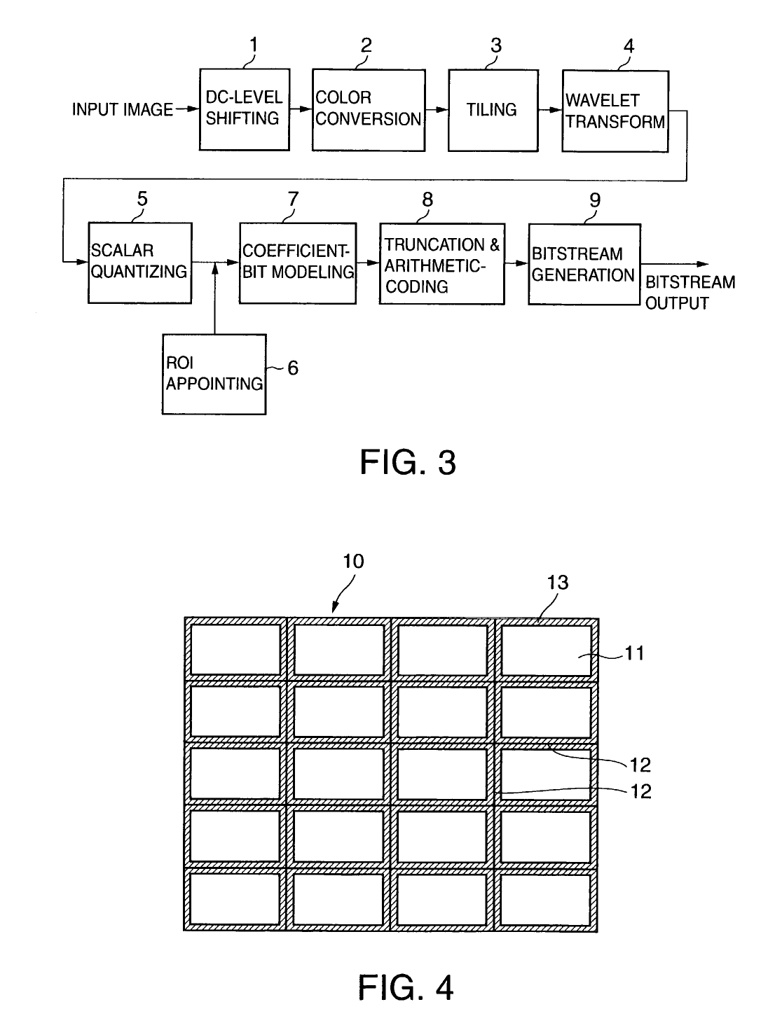

FIG. 3 shows a block diagram of an embodiment of image encoder under JPEG2000, equipped with a DC-level shifter 1, a color converter 2, a tiling unit 3, a wavelet transformer 4, a scalar quantizer 5, a ROI (Region of Interest) appointer 6, a coefficient-bit modeling unit 7, a truncation/arithmetic-coder 8 and a bitstream generator 9.

The units other than the wavelet transformer 4, the truncation/arithmetic-coder 8 and the bitstream generator 9 are options under JPEG2000.

The DC-level shifter 1, the color converter 2 and the tiling unit 3 perform processing to the entire regions of input image whereas the remaining units 4 to 9 perform processing to each tile block.

In operation, an input image supplied to the DC-level shifter 1 undergoes DC-level shifting with a zero component (DC component), as a threshold level. For example, an 8-bit input image data, belonging to a value range from 0 to 255, can be shifted by DC-level shifting to another in a range from −128 to 127 with 0 as the center value.

DC-level shifting minimizes the maximum absolute value of the image data, thus reducing D.C. components of images.

The DC-level shifted image is supplied to the color converter 2 for color conversion from RGB color space to YUV color space for high encoding efficiency.

The color-converted image is then supplied to the tiling unit 3 and divided into several tile blocks with no relations each other. The tiling process enables parallel processing to the tile blocks having no relations each other for high wavelet-transformation speed. Wavelet transform without tiling process could suffer low transform speed due to heavy computation amount and large memory capacity.

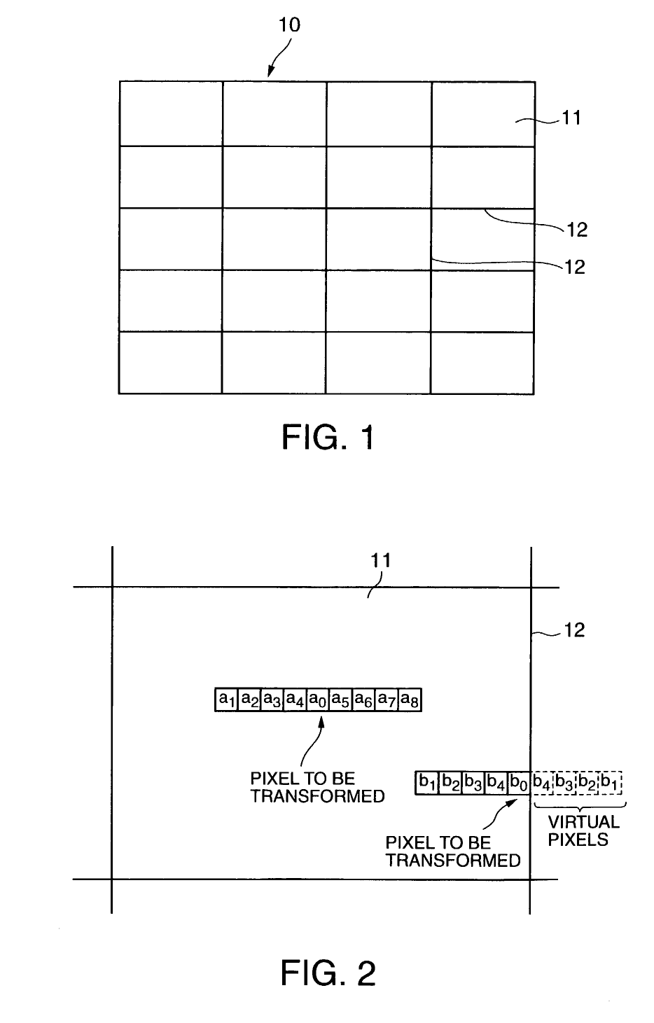

An input image 10 that has undergone the DC-level shifting and color conversion is divided into several tile blocks 11 with tile border lines 12, like shown in FIG. 1.

The tiled image data is supplied to the wavelet transformer 4 for wavelet transform in each tile block 11, thus wavelet-transformed coefficients (called DWT coefficients hereinafter) being obtained.

Wavelet transform is a waveform-data analyzing technique for analyzing complex waveforms with Fourier analysis while simultaneously trapping waveform portions varying in time or space. It is performed to images for low- and high spatial-frequency components, separately. Integer type wavelet transform uses integers for transform coefficients. Real-number type wavelet transform uses real numbers for transform coefficients. Reversible transform is available for the former type with small circuitry. The latter type offers high image quality at high compression rate, but no reversible transform available.

In image processing, transform coefficients, the number of reference pixels can be set freely in wavelet transform, thus several types of transform filters are available.

The integer type wavelet transform uses a (5×3) filter in which the numbers of reference pixels in low and high spatial-frequency ranges are 5 and 3, respectively, under JPEG2000. The real-number type wavelet transform uses a (9×7) filter in which the numbers of reference pixels in low and high spatial-frequency ranges are 9 and 7, respectively, under JPEG2000.

The transformed data (DWT coefficients) from the wavelet transformer 4 is divided by a specific value to be quantized into scalar values in the scalar quantizer 5. The ROI appointer 6 sets regions of interest for the quantized data or for the wavelet-transformed data if no quantization performed.

A region of interest (ROI) is a region to be encoded so that the amount of original image data lost in compression can be smaller than the other regions and decoded with less image deterioration. In other words, the region of interest is a region to be encoded at compression rate lower than the other regions or a region which will not undergo compression.

For example, in digital-camera photographing, an important object such as a person centered in an image can be appointed as an ROI so that it will not be lost in encoding and thus can be reproduced at high fidelity when decoded.

Image-data compression rate is roughly set at the scalar quantizer 5 and then precisely set at the truncation/arithmetic-coder 8.

The DWT coefficients quantized by the scalar quantizer 5 and ROI-appointed by the ROI appointer 6 are supplied to the coefficient-bit modeling unit 7.

Coefficient-bit modeling processes a plurality of DWT coefficients of several binary digits per bit plane so that the DWT coefficients can be sliced per certain number of digits.

Coefficient-bit modeling uses Max Shift algorithm under JPEG2000 to shift the DWT coefficients, ROI-appointed by the ROI appointer 6, into the most-significant bit (MSB) side. Thus, the coefficient-bit modeling unit 7 generates a bit train.

The coefficient-bit modeling resultant bit train is supplied to the truncation/arithmetic-coder 8 (having an MQ-Coder) for truncation and arithmetic coding.

The truncation is a process of truncating some bits of the bit train generated by the coefficient-bit modeling. It is known that image data will suffer low image quality when MSB-side bits are truncated whereas retain relatively high image quality when LSB (Least-Significant Bit)-side bits are truncated.

Some bits are truncated from LSB in general. A compression rate is then decided in accordance with up to which digit from MSB remains with no truncation.

The truncation/arithmetic-coder 8 does, however, not apply truncation to the bit train in the regions appointed as ROIs by the ROI appointer 6 under determination as to whether a bit train is the one existing in the ROI-appointed regions, based on detection of data-to-MSB-side shifting (by Max Shift algorithm).

Moreover, the bit truncation/arithmetic-coder 8 encodes the truncated bit train into byte codes. This arithmetic coding is one type of bit-train compression technique.

The bit train output from the truncation/arithmetic-coder 8 is supplied to the bitstream generator 9, thus a bitstream being generated, while the order of Y-, U- and V-color components, resolution, signal-to-noise ratio, etc., is decided based on preset priority.

The ROI appointer 6 can be used for an image encoder installed in digital cameras, for appointing regions of an object to be photographed as regions of interest that should retain high image quality.

In addition to this function, the ROI appointer 6 in this invention has a function of appointing specific regions around the tile border lines as regions of interest for tile-noise suppression.

Illustrated in FIG. 4 is an image for which several regions have been appointed as the regions of interest by the ROI-appointing function.

In detail, the input image 10 has been divided into several tile blocks 11 with the tile border lines 12. A region of interest (ROI) 13 has been set along the tile border lines 12 in each tile block 11.

Although not limited, the ROI 13 may have a width corresponding to at least 3 pixels in integer type wavelet transform with (5×3) filtering or at least 5 pixels in real-number type wavelet transform with (9×7) filtering.

Data-lossless image compression is achieved at least in the ROIs 13 appointed by the ROI appointer 6, for the scalar quantizer 5, the ROI appointer 6 and the truncation/arithmetic-coder 8 after computation by the wavelet transformer 4, or very few data could be lost from the ROIs 13 compared to the other regions. This function thus allows reproduction of high-quality images with almost no tiling noises even the images have undergone compression at low bit rate, or high compression rate.

The ROI appointing for tile-noise suppression in the image encoder of this embodiment always functions during encoding, regardless of image compression rate.

It seems, however, that the ROI-appointing may function only when image compression is performed at a specific low bit rate or lower that could cause tiling noises if decoding is basically always performed at the specific bit rate or higher under JPEG2000.

Nevertheless, when the present invention is applied to camcoders (and also digital cameras, moving-picture data of which will be reproduced by other equipment), it is preferable that the ROI appointing for tile-noise suppression always functions during encoding, regardless of image compression rate. This is because decoding may sometimes be performed at the specific bit rate or lower in such applications.

It is of course preferable to set the ROI-appointing function to work only under compression at the specific low bit rate or lower for applications such as digital cameras in which still-or moving-picture data will be reproduced on a built-in liquid-crystal display at fixed bit rate.

The present invention utilizes the ROI-appointing function for tile-noise suppression in addition to lossless processing as the original purpose, thus suffers decrease in the maximum compression rate. The area of each ROI 13 shown in FIG. 4 is, however, very small compared to the entire image area, thus decrease in the maximum compression rate is very small, hence causing almost no problems in actual use.

The embodiment shown in FIG. 3 is equipped with the color converter 2 for color input images. It can of course be omitted for monochrome images. The DC-level shifter may also be omitted in some cases.

The present invention also includes a software program that will run on a computer to work as the image encoder as disclosed above.

The program as an embodiment includes:

a computer-readable program code means for dividing an input image into a plurality of tile blocks;

a computer-readable program code means for applying wavelet transform to each tile block;

a computer-readable program code means for appointing at least one region of the wavelet-transformed data as a region of interest, the region to be appointed as the region of interest being located in each tile block and in the vicinity of tile border lines;

a computer-readable program code means for applying coefficient-bit modeling to the transformed data for which the region of interest has been set, thus a bit train being generated;

a computer-readable program code means for truncating specific bits of the bit train and converting the truncated bit train into byte codes; and

a computer-readable program code means for generating a bitstream based on the truncated and byte-code-converted bit train.

The region-appointing computer-readable program code means may include a computer-readable program code means for carrying out the region appointment only when a compression rate for the input image reaches a certain level or higher.

The software program listed above may be stored in a storage medium and installed in a computer. Or it may be distributed via a communications network and installed in a computer.

The present invention utilizes the region-of-interest appointing function defined in JPEG2000 as an optional function to prevent tiling noises, with almost no effects on image quality and processing speed, which may otherwise occur in wavelet transform for each tile block, one of peculiar problems in JPEG2000.

In other words, the present invention solves the problem of tiling noises with the region-of-interest appointing function that has generally been applied, for example, to objects to be photographed for lossless processing.

As disclosed above, the present invention achieves tiling-noise prevention with almost no effects on image quality and processing speed with the region-of-interest appointing function to appoint some regions of each tile block in the vicinity of tile border lines.

What is claimed is:

1. An image encoder for compressing an input image, comprising:
a tiling unit to divide the input image into a plurality of tile blocks;
a wavelet transformer to apply wavelet transform to each tile block;
a region-of-interest appointer to appoint at least one region of the wavelet-transformed data as a region of interest, the region to be appointed as the region of interest being located in each tile block and in the vicinity of tile border lines;
a coefficient-bit modeling unit to apply coefficient-bit modeling to the transformed data for which the region of interest has been set, thus generating a bit train;
a truncation/arithmetic-coder to truncate specific bits of the bit train and convert the truncated bit train into byte codes; and
a bitstream generator to generate a bitstream based on the truncated and byte-code-converted bit train.

2. The image encoder according to claim 1, the region-of-interest appointer carries out the region appointment only when a compression rate for the input image reaches a certain level or higher.

3. A method of image encoding to compress an input image, comprising the steps of:
dividing the input image into a plurality of tile blocks;
applying wavelet transform to each tile block;
appointing at least one region of the wavelet-transformed data as a region of interest, the region to be appointed as the region of interest being located in each tile block and in the vicinity of tile border lines;
applying coefficient-bit modeling to the transformed data for which the region of interest has been set, thus a bit train being generated;
truncating specific bits of the bit train and converting the truncated bit train into byte codes; and
generating a bitstream based on the truncated and byte-code-converted bit train.

4. The method of image encoding according to claim 3, wherein the region-of-interest appointing step includes the step of carrying out the region appointment only when a compression rate for the input image reaches a certain level or higher.

5. A computer-readable program for compressing an input image, comprising:
computer-readable program code means for dividing an input image into a plurality of tile blocks;
computer-readable program code means for applying wavelet transform to each tile block;
computer-readable program code means for appointing at least one region of the wavelet-transformed data as a region of interest, the region to be appointed as the region of interest being located in each tile block and in the vicinity of tile border lines;
computer-readable program code means for applying coefficient-bit modeling to the transformed data for which the region of interest has been set, thus a bit train being generated;
computer-readable program code means for truncating specific bits of the bit train and converting the truncated bit train into byte codes; and
computer-readable program code means for generating a bitstream based on the truncated and byte-code-converted bit train.

6. The computer-readable program according to claim 5, wherein the region-appointing computer-readable program code means includes computer-readable program code means for carrying out the region appointment only when a compression rate for the input image reaches a certain level or higher.
